(19) United States
(12) Patent Application Publication
(10) Pub. No.: US 2020/0320820 A1
(43) Pub. Date: Oct. 8, 2020

(54) GAMING TABLE DEVICE

(71) Applicant: GAMING PARTNERS INTERNATIONAL, Savigny-les-Beaune (FR)

(72) Inventors: Cyril BROS, Marseille (FR); Frédéric DUCHÊNE, Carry-Le-Rouet (FR); Emmanuel GELINOTTE, Savigny-Les-Beaune (FR)

(73) Assignee: GAMING PARTNERS INTERNATIONAL, Savigny-les-Beaune (FR)

(21) Appl. No.: 16/303,792

(22) PCT Filed: May 22, 2017
(86) PCT No.: PCT/FR2017/051241

§ 371 Date: Nov. 21, 2018

(30) Foreign Application Priority Data
May 24, 2016 (FR) 1654652

(51) Int. Cl. G07F 17/32

(52) U.S. Cl. CPC G07F 17/322; G07F 17/3209; G07F 17/3239; G07F 17/3223; G07F 17/3211

(57) ABSTRACT

A gaming-table device (T) comprising:
a gaming table that defines a playing zone (ZT3, ZNT1) that is fitted with a detection and identification system (SDT1, SDNT1) for identifying and detecting items;
a computer (12) that is provided with software that is capable of retrieving and analyzing detection information that is sent by the item detection and identification system (SDT1, SDNT1);
chips that are placed on an identified playing zone, so that the detection system (SDT1, SDNT1) generates detection information that is sent to the computer (12) so as to be analyzed thereby; and
software that generates action information as a result of analyzing detection information, the action information being sent to an identified playing zone (ZT3, ZNT1) so as to activate a specific function that can be used by a player.

The present invention relates to a gaming-table device, in particular of the casino type, comprising a gaming table with a gaming mat that defines at least one playing zone and chips and/or tokens for placing on the gaming mat, and in particular on the playing zone. The advantageous field of application for the present invention is thus the field of equipment for casinos and gaming rooms.

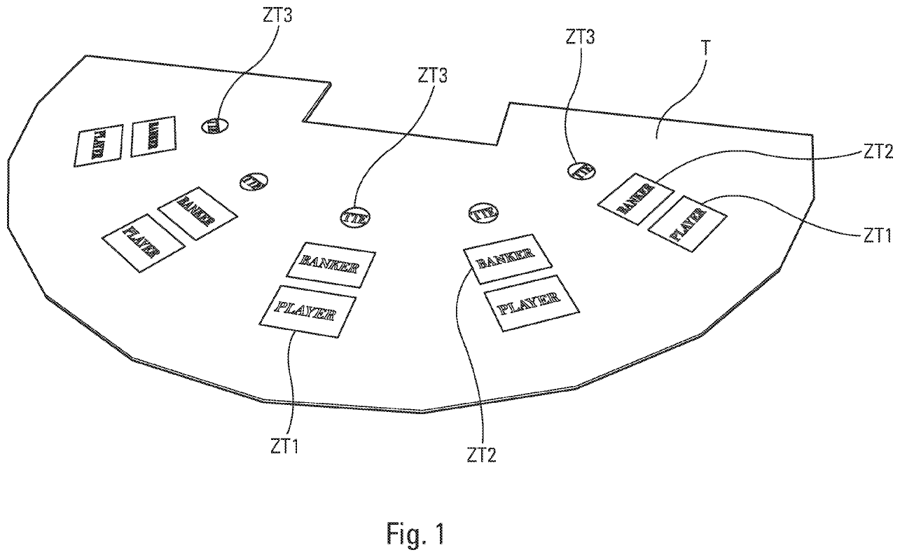

A conventional gaming table is designed to receive one or more players, and a croupier. Its gaming mat is designed as a function of the type of game: poker, baccarat, blackjack, roulette, SicBo, craps, and their variants. A conventional table for baccarat is shown in FIG. 1. Five series of playing zones ZTi can be seen, each comprising a “PLAYER” playing zone, a “BANKER” playing zone, and a “TIE” playing zone, arranged in a fan configuration around a recess in which the croupier is positioned.

In the prior art, gaming chips and/or tokens already exist that are provided with detectable means, such as a radio frequency identification (RFID) integrated circuit. There also exist gaming tables having one or more playing zones that are fitted with detectors for detecting detectable gaming chips and/or tokens. The detectors are arranged under the gaming mat at certain playing zones.

When a player places gaming chips and/or tokens on a playing zone of the gaming table in order to place a bet, they are detected in real time and their identification elements are sent to a computer electronically. The computer retrieves the information and can compare it to a database in order to verify that the betting elements (chip—token) are authorized to be used and/or that they are not counterfeit.

The detectors and the computer thus make it possible to collect information about the authenticity, the identity, the location, the value, and the quantity of chips and tokens placed on certain playing zones of the gaming mat. The players are not aware that their bets are being analyzed in this way and they do not even know that it is being done. In any event, there is no interference between this information and the way the game is played and the players make their decisions.

An object of the present invention is to improve the experience of the players at a casino table without compromising the initial game returns and the security of the table.

The main purpose of the device of the present invention is to analyze closely the players' bets at a gaming table, in particular so as to generate gradual variation in bets, in order to bring new playing functions automatically to the players, but without putting additional stress on the croupier, nor slowing down the game, nor making it too complicated. Still more generally, an object of the device of the present invention is to create interaction between players and the information collected by the detectors and the computer.

For this purpose, the invention proposes a gaming-table device, in particular of the casino type, the device being characterized in that it comprises:
at least one gaming table with a gaming mat that defines at least one identified playing zone that is precisely defined locally, the playing zone being fitted with at least one detection and identification system for identifying and detecting items, such as chips and/or tokens, dice, playing cards, and/or laptop computers;
at least one computer that is provided with software that is capable of retrieving and analyzing detection information that is sent by the item detection and identification system of said at least one playing zone;
chips and/or tokens that are placed on the gaming mat, and in particular on said at least one identified playing zone, so that the item detection and identification system of said playing zone generates detection information that is sent to the computer so as to be analyzed thereby; and
software of the computer, which software further generates action information as a result of analyzing detection information, the action information being sent to an identified playing zone that may be the zone from which the detection information came or that may be some other identified playing zone, the identified playing zone that receives the action information activating a specific function that can be used by a player, thereby offering said player additional playing means.

In contrast to a conventional gaming table, the gaming table of the present invention offers interactivity with the players, offering them various functions. Among the functions offered to the players, it is possible to take as examples the activation of a new playing zone following a bet of a certain amount, or the multiplying of loyalty points by a multiplier that depends on the settable betting ranges.

The main underlying technique is based on detecting bets on a very precisely defined playing zone, regardless of its position and its size relative to other playing zones, in the sense that a bet is associated in independent and reliable manner with a single playing zone. This analysis is made possible by identifying, in independent manner and in real time, for each player, the very precise locations of a multitude of bets, optionally in piles of chips, on the surface of the table, and their amounts, by means of a system of recognizing and identifying casino chips and tokens.

This precisely localized detection is associated with the ability to interpret the information sent by each playing zone to a computer in order to monitor the players' bets, and to interpret those bets as a function of the game and of the state of play, so as to deduce therefrom a continuation for the play of the game.

When a player places gaming chips and/or tokens on a precise zone of the gaming table in order to place a bet, the elements are detected in real time and their identification elements are sent electronically to a computer. With the information sent by the playing zone, the computer deduces therefrom the amount of the bet corresponding to the playing zone, which it compares with the rules and functions of the current game, so as to deduce therefrom a continuation for the play of the game. In a preferred embodiment, the rules and functions are compared by interrogating a database.

More precisely, it is possible to list the following embodiments:
the identified playing zone is not visibly located on the gaming mat while it is not activated;
the identified playing zone is defined by a light source that is triggered by the action information, thereby informing the player that the identified playing zone is activated;
the identified playing zone is a touch screen that is incorporated in the gaming table, that is associated with the table, or even a touch screen of a laptop computer, a smartphone, or a tablet;
a screen associated with the identified playing zone displays visual information that can be read in relation with the action information;
the item detection and identification system comprises a wireless sensor of the RFID, near field communication (NFC), Bluetooth, Infrared, or WIFI type, enabling the player to place a laptop computer and/or a loyalty card on the identified playing zone that is thus detected and then identified using a suitable process;
the activated identified playing zone offers the player additional playing means;
the computer is positioned in the proximity of the gaming table and/or remotely and connected to a computer network;
the computer retrieves and analyzes detection information coming from playing zones situated on a single gaming table or on a plurality of distinct tables;
the information received by the computer enables the software:
to measure the amount of a bet on a single playing zone;
to associate a bet amount with a single playing zone or with a group of playing zones, by addition;
to associate a bet or a group of bets with an entity that is uniquely identified;
to send information to one or more playing zones as a function of its analysis; and
the software compares the results of its analysis with information that is contained in a database, so as to send action information to said at least one identified playing zone.

All of the operations performed after sending information from the playing zone as mentioned above may thus be performed by a single computer or by a group of computers in which each computer has a well-defined role.

The continuation for the play of the game as deduced by the computer may be “physical”, e.g. the return of information to another playing zone that is then activated and as a result accepts the detection of gaming bets.

The continuation for the play may be “virtual”, e.g. updating information in databases. This updating of the database might then lead to an action associated with the current game.

The continuation for the play is not exclusively “physical” or “virtual”, but may specifically lead to both of these consequences.

Advantageously, at least one playing zone is capable of detecting and identifying detectable elements other than gaming chips and tokens, such as a membership card (or loyalty card) or an electronic device (laptop computer, mobile telephone, tablet).

The detection of a membership card thus enables the device to associate a bet with a player's account, serving mainly to implement the “virtual” continuation for the play of the game.

Detecting an electronic device thus makes it possible to identify a player and to cause the player's bets to interact with software that is incorporated in the electronic device, serving mainly to implement the “physical” continuation for the play of the game.

Other characteristics and advantages of the present invention appear from the following description, made with reference to the accompanying drawings which show embodiment examples that are not limiting in any way.

In the drawings:

FIG. 1 shows a conventional gaming table as seen by a player, with the playing zones marked on the mat of the gaming table.

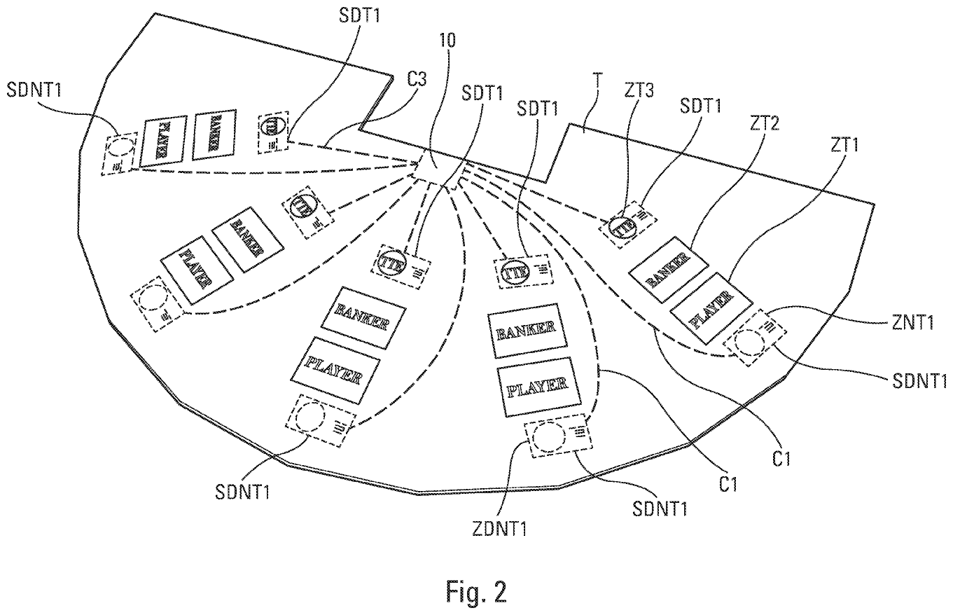

FIG. 2 shows a gaming table with the playing zones that are optionally made visible and that are fitted with a respective detection system.

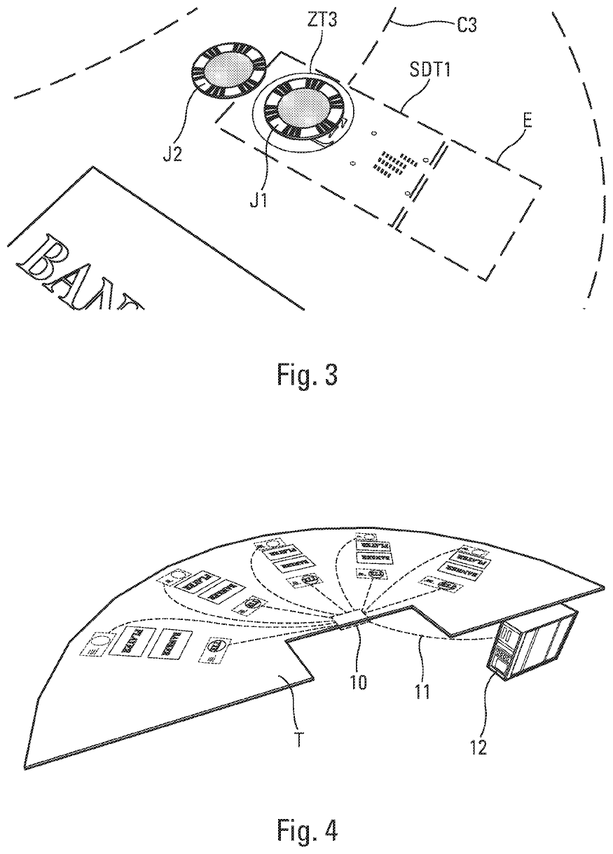

FIG. 3 shows a detail of a playing zone that is visibly marked on the mat of the gaming table and that is fitted with a detection system.

FIG. 4 shows a complete hardware architecture for implementing the device of the invention.

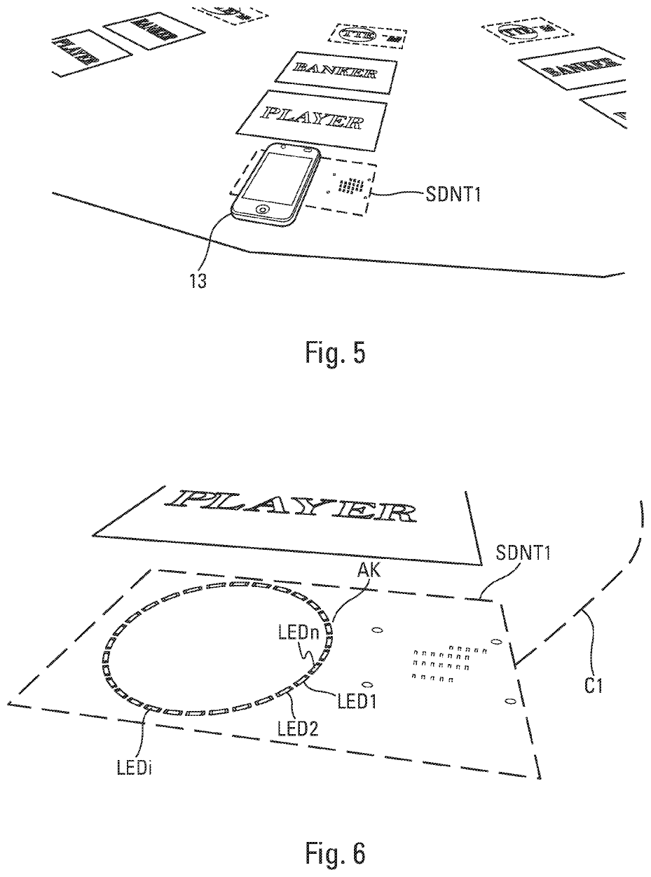

FIG. 5 shows an unmarked playing zone that detects the presence of a mobile device.

FIG. 6 shows a playing zone that is fitted with a detection system and that is provided with light-emitting diodes (LEDs) at the periphery of the playing zone.

As mentioned above, FIG. 1 shows a baccarat gaming table T, similar to the prior art, that does not have the device of the invention. The player sees five series, each of three playing zones ZT1, ZT2, and ZT3 marked on the gaming mat that are betting zones, namely zones in which chips and/or tokens are placed in order to place bets, namely a “PLAYER” playing zone, a “BANKER” playing zone, and a “TIE” playing zone. In this embodiment, the zones are exclusively betting zones, but this is not essential. The number of series and the number of zones in each series is purely illustrative, and in no way limiting.

FIG. 2 shows a gaming table T that may be the FIG. 1 gaming table, but that is now provided with detection and identification systems for detecting and identifying gaming elements, which systems are placed under the playing zones, which themselves are optionally marked.

A detection and identification system SDT1 positioned under a playing zone ZT3 marked on the gaming mat T makes it possible to detect specific gaming elements (chips J1, J2, tokens, dice) that are fitted with detectable means (e.g. RFID, NFC) and that are placed exclusively within the surface area defined by the marking on the mat and visible to the player, in accordance with the rules of the game in question. Nevertheless, a detection and identification system SDT1 may be capable of detecting any other gaming elements (telephones, membership cards, . . . ) having a size that is not limited by the surface area defined by the mark. It is not essential for all of the marked zones ZT1, ZT2, and ZT3 to be fitted with a respective detection and identification system SDTk.

A detection and identification system SDNT1 positioned under a playing zone ZNT1 that is not marked on the mat T makes it possible to detect various gaming elements, not only chips J1, J2 and tokens but also other elements. It is the functions provided by the invention that mainly define the use of the zone. There are no constraints on the number of detection and identification systems for playing zones that are not marked on the mat.

In FIG. 2, the playing zone ZT3 is a marked or visible zone that the player can easily locate, whereas the playing zone ZNT1 is not marked and thus cannot be seen so long as it is not activated.

All of the systems SDT1 and SDNT1 may be provided with respective wired connections C1 and C3 that connect them to a data concentrator 10. The connections may be two-way, namely transmitting information from each detection and identification system SDT1 or SDNT1 to the concentrator 10, and also transmitting information from the concentrator 10 to at least one detection and identification system SDT1 and/or SDNT1. However, the transfer of information from or to a detection and identification system may be performed using wireless technology.

FIG. 3 shows both a detection and identification system SDT1 positioned under the marked playing zone ZT3 (TIE), and also the wired connection C3. The detection and identification system SDT1 may have a surface area that is greater than the corresponding marked zone ZT3, but it is made so as to detect specific gaming elements (chips/tokens) only when they are placed within the surface area of the marked zone ZT3. Thus, in FIG. 3, the chip J1 is detected and identified by SDT1, whereas the chip J2 is not detected. In FIG. 3, it should also be observed that a screen E may be associated with the zone ZT3 for communicating readable information to the player. In this embodiment, the screen E is situated adjacent to the zone ZT3, but it is also possible to incorporate it in the zone, or, on the contrary, to offset it further away from the zone. The screen E is activated at the same time as the zone ZT3, or later.

FIG. 4 shows an architecture that is possible, but not limiting, for complete implementation of the invention, in which the gaming table T is fitted with the concentrator 10 that is connected to a computer 12 by means of a cable 11. In this architecture, the software installed on the computer 12 asks the concentrator 10 for information about the gaming elements detected on the optionally-marked playing zones provided on the table T, which information is conveyed through the cable 11. In this same architecture, the software sends information to the concentrator 10 in response to the previously-received information.

Other architectures are possible, such as the use of a plurality of computers and/or pieces of software in order to perform the tasks of the software installed on the computer 12 shown in FIG. 4. Another possible architecture is to replace the concentrator 10 and its cable 11 with wireless communication between the detection systems installed in the table T and the computer 12.

FIG. 5 shows a detection and identification system SDNT1 positioned under an unmarked playing zone ZNT1, that is capable of detecting and identifying an electronic device placed on the gaming mat T, in non-limiting manner on the detection surface area of the system SDNT1. Compared to the gaming elements specific to a real bet (chips/tokens), the detection and identification of the electronic device is not restricted to the surface area of an equivalent marked zone, as in FIG. 3.

The detection and identification system SDNT1 may also send information to the electronic device as a function of the rules specific to the game and of the state of play. A simple example of use is to send the amount of a player's bet to the electronic device so as to display the value on the screen.

FIG. 6 shows a detection and identification system SDNT1, and its wired connection C1, positioned under an unmarked playing zone ZNT1, and provided with an LED strip at the periphery of its detection surface area Ak. On receiving specific information via the connection C1, the detection system SDTN1 controls the LEDs individually or in groups or as a whole. Control of the LEDs enables an unmarked playing zone ZNT1 to appear visually on the mat T, and thus enables an active playing zone to be added for the player. The new playing zone as made visible in this way is not exclusively for detecting and identifying specific gaming elements (chips, tokens).

Very generally, the software of the computer 12 generates action information as a result of analyzing detection information sent by the item detection and identification system SDT1, SDNT1 of at least one playing zone ZT3, ZNT1 on which one or more detectable gaming elements are placed, the action information then being sent to an identified playing zone that may be the zone from which the detection information came or that may be another identified playing zone, the identified playing zone that receives the action information activating a specific function that can be used by a player. The placing of one or more chips or tokens on a playing zone that is provided with a detection and identification system may thus activate:
a new playing zone on which the player can place a bet;
a new playing zone on which the user can place a telephone, a tablet, or a laptop computer, or even a membership or loyalty card;
light sources (e.g. LEDs) that define a new playing zone;
a screen that is associated with a marked playing zone or with a newly activated playing zone for communicating readable information to the player;
a touch screen that may be incorporated in the gaming table and that is associated with the table, or even a touch screen of a laptop computer, a telephone, or a tablet that is connected (e.g. by WIFI or Bluetooth) to the table;
a new function or an additional function of the playing zone in which the chips or tokens have been placed;
additional playing means.

By delivering information to the playing zones or directly to the players, the device of the invention creates interactivity and increases the functions that the player can use in order to adapt gaming strategy, increase chances of winning, diversify tactics, advantageously accumulate loyalty card points, etc.

Example: an application of the invention with a “virtual” effect of a player's bet

All of the “TIE” zones of a baccarat table are fitted with the detection system for detecting chips and tokens.

For each player, another playing zone (“PLAYER” or “BANKER” or a dedicated zone) is capable of reading a player's membership card associated with the player's loyalty-points account.

Once the device of the invention has recognized the client's account, said client is able to compare the bets placed on the player's “TIE” zone with a database table that defines a multiplier for loyalty points acquired as a function of the bet.

Thus, by way of example, if the amount of the bet lies in a betting range that enables the player to multiply by 2 the loyalty points that would normally be acquired, then the device automatically adds this new number of loyalty points to the player's account.

Example: an application of the invention with a “physical” effect of a player's bet

Each main betting zone of a blackjack table is fitted with the detection system for detecting chips and tokens.

Beside each main betting zone there is situated another playing zone that is not marked on the mat (thus not visible to the player) and that is fitted with LEDs at its periphery.

The device is thus capable of detecting the player's bet on the player's main betting zone, and of comparing it to a database table that defines a minimum-bet threshold that enables a second betting zone to be activated.

Thus, if a player places a bet above the threshold, the device sends information to the unmarked playing zone on the mat so that the LEDs light up and thus cause a new active playing zone to appear that is visible to the player.

By means of the invention, detecting a certain chip and/or token value in an initial playing zone causes new gaming opportunities to be activated in a new playing zone or even in the initial playing zone, and the player can use these opportunities in order to change the play of the current game or in order to access another game. The activated playing zone may be incorporated in the gaming table, being made visible during activation, or it may be associated with the table, or it may even be formed by the touch screen of a smartphone. The player thus has the possibility of acting directly on the play of the game, by deciding whether or not to take up the opportunities that are offered as a function of the bets that have been placed. This interactivity makes it possible to increase considerably the extent of game strategies.

1. A gaming-table device, in particular of the casino type, the device being characterized in that it comprises:
at least one gaming table (T) with a gaming mat that defines at least one identified playing zone (ZT3, ZNT1) that is precisely defined locally, the identified playing zone (ZT3, ZNT1) being fitted with at least one detection and identification system (SDT1, SDNT1) for identifying and detecting items, such as chips (J1, J2) and/or tokens, dice, playing cards, and/or electronic devices (13);
at least one computer (12) that is provided with software that is capable of retrieving and analyzing detection information that is sent by the item detection and identification system (SDT1, SDNT1) of said at least one playing zone (ZT3, ZNT1);
chips (J1, J2) and/or tokens that are placed on the gaming mat, and in particular on said at least one identified playing zone (ZT3, ZNT1), so that the item detection and identification system (SDT1, SDNT1) of said playing zone (ZT3, ZNT1) generates detection information that is sent to the computer (12) so as to be analyzed thereby; and
software of the computer (12), which software further generates action information as a result of analyzing detection information, the action information being sent to an identified playing zone (ZT3, ZNT1) that may be the zone from which the detection information came or that may be some other identified playing zone, the identified playing zone that receives the action information activating a specific function that can be used by a player, thereby offering said player additional playing means.

2. A gaming-table device according to claim 1, wherein the identified playing zone (ZNT1) is not visibly located on the gaming mat while it is not activated.

3. The gaming-table device according to claim 1, wherein the identified playing zone (ZNT1) is defined by a light source (LED) that is triggered by the action information, thereby informing the player that the identified playing zone is activated.

4. The gaming-table device according to claim 1, wherein the identified playing zone (ZNT1) is a touch screen.

5. The gaming-table device according to claim 1, wherein a screen (E) associated with the identified playing zone (ZT3) displays visual information that can be read in relation with the action information.

6. The gaming-table device according to claim 1, wherein the item detection and identification system (SDT1, SDNT1) comprises a wireless sensor of the RFID, (NFC), Bluetooth, Infrared, or WIFI type, enabling the player to place an electronic device and/or a membership card on the identified playing zone that is thus detected and then identified using a suitable process.

7. The gaming-table device according to claim 1, wherein the computer (12) is positioned in the proximity of the gaming table and/or remotely and connected to a computer network.

8. The gaming-table device according to claim 1, wherein the computer (12) retrieves and analyzes detection information coming from playing zones situated on a single gaming table or on a plurality of distinct tables.

9. The gaming-table device according to claim 1, wherein the information received by the computer (12) enables the software:
to measure the amount of a bet on a single playing zone;
to associate a bet amount with a single playing zone or with a group of playing zones, by addition;
to associate a bet or a group of bets with an entity that is uniquely identified;
to send information to one or more playing zones as a function of its analysis.

10. The device according to claim 9, wherein the software compares the results of its analysis with information that is contained in a database, so as to send action information to said at least one identified playing zone.
